(19) United States
(12) Patent Application Publication
(10) Pub. No.: US 2023/0421810 A1
(43) Pub. Date: Dec. 28, 2023

(54) ENCAPSULATION AND DECAPSULATION METHODS AND APPARATUSES FOR POINT CLOUD MEDIA FILE, AND STORAGE MEDIUM

(71) Applicant: TENCENT TECHNOLOGY (SHENZHEN) COMPANY LIMITED, Shenzhen (CN)

(72) Inventor: Ying HU, Shenzhen (CN)

(21) Appl. No.: 18/463,765

(22) Filed: Sep. 8, 2023

Related U.S. Application Data
(63) Continuation of application No. PCT/CN2022/109620, filed on Aug. 2, 2022.

(30) Foreign Application Priority Data
Sep. 1, 2021 (CN) 202111022386.2

(51) Int. Cl. H04N 19/597

(52) U.S. Cl. CPC H04N 19/597

(57) ABSTRACT

This application provides encapsulation and decapsulation methods and apparatuses for a point cloud media file, and a storage medium. The methods comprises acquiring a target point cloud and encoding the target point cloud to obtain a bitstream, the target point cloud comprising at least one type of attribute information, each type of attribution information comprising M attribute instances of instance data, and M being a positive integer greater than 1; and encapsulating the bitstream of the target point cloud according to first feature information of at least one attribute instance of M attribute instances to obtain a media file, the media file comprising the first feature information of the at least one attribute instance.

### RELATED APPLICATIONS

This application claims the priority of PCT Application No. PCT/CN2022/109620,filed on Aug. 2, 2022, which claims priority to Chinese Patent Application No. 202111022386.2, entitled “ENCAPSULATION AND DECAPSULATION METHODS AND APPARATUSES FOR POINT CLOUD MEDIA FILE, AND STORAGE MEDIUM”, filed by the China National Intellectual Property Administration on Sep. 1, 2021. The content of both applications are hereby incorporated by reference in their entirety.

### FIELD OF THE TECHNOLOGY

The embodiments of this application relate to the field of video processing, and particularly to encapsulation and decapsulation methods and apparatuses for a point cloud media file, and a storage medium.

### BACKGROUND OF THE DISCLOSURE

A point cloud is a set of discrete points which are randomly distributed in space and represent the spatial structure and surface attribute of a three-dimensional object or scene. Point cloud media can be divided into 3 degrees of freedom (DoF) media, 3DoF+media, and 6DoF media according to the degree of freedom of a user when consuming the media content.

Each point in the point cloud includes geometry information and attribute information. The attribute information includes different types of attribute information, such as colour attribute and reflectance. The same type of attribute information may also include different attribute instances. For example, the colour attribute of a point includes different colour types, and the different colour types are referred to as different attribute instances of the colour attribute. Encoding technologies, such as geometry-based point cloud compression (GPCC), support multiple attribute instances of the same attribute type comprised in a bitstream.

### SUMMARY

This application provides encapsulation and decapsulation methods and apparatuses for a point cloud media file, and a storage medium, which can selectively consume an attribute instance according to first feature information of at least one attribute instance of M attribute instances added to the media file, thereby saving decoding resources and improving the decoding efficiency.

The embodiments of this application provide an encapsulation method for a point cloud media file, applied to a file encapsulation device. The methods includes acquiring a target point cloud and encoding the target point cloud to obtain a bitstream, the target point cloud comprising at least one type of attribute information, each type of attribution information comprising M attribute instances of instance data, and M being a positive integer greater than 1; and encapsulating the bitstream of the target point cloud according to first feature information of at least one attribute instance of M attribute instances to obtain a media file, the media file comprising the first feature information of the at least one attribute instance.

The embodiments of this application provide a decapsulation method for a point cloud media file, applied to a file decapsulation device, the method including receiving first information transmitted by a file encapsulation device, the first information indicating first feature information of at least one attribute instance of M attribute instances in a target point cloud, and M being a positive integer greater than 1; and determining a target attribute instance from the at least one attribute instance using the first feature information, and acquiring instance data corresponding to the target attribute instance.

The embodiments of this application also provide a non-transitory computer-readable storage medium, configured to store a computer program for causing a computer to perform the method of any one of the above first to second aspects or a method in each implementation thereof.

In summary, the file encapsulation device of the embodiments of this application encapsulates first feature information of at least one attribute instance of M attribute instances in the media file of the target point cloud as metadata of instance data corresponding to the at least one attribute instance. The target point cloud includes the instance data corresponding to the M attribute instances of at least one type of attribute information. In the embodiments of this application, the first feature information of the attribute instance is added to the media file as the metadata such that the file decapsulation device can determine the target attribute instance to be specifically decoded according to the first feature information in the metadata, thereby saving broadband and decoding resources and improving the decoding efficiency.

### BRIEF DESCRIPTION OF THE DRAWINGS

In order to illustrate the technical solutions of the embodiments of the present disclosure more clearly, the drawings that need to be used in the description of the embodiments will be briefly described below. It is apparent that the drawings in the following description are only some embodiments of the present disclosure, and other drawings can be obtained by those skilled in the art according to the drawings without creative work.

FIG. 1 shows a schematic illustration of 3 degrees of freedom (DoF).

FIG. 2 shows a schematic illustration of 3DoF+.

FIG. 3 shows a schematic illustration of 6DoF.

FIG. 4A is an architecture diagram of an immersive media system provided in an embodiment of this application.

FIG. 4B is a content flowchart of V3C media provided in an embodiment of this application.

FIG. 5 is a flowchart of an encapsulation method for a point cloud media file provided in an embodiment of this application.

FIG. 6 is a flowchart of interactive encapsulation and decapsulation methods for a point cloud media file provided in an embodiment of this application.

FIG. 7 is a flowchart of interactive encapsulation and decapsulation methods for a point cloud media file provided in an embodiment of this application.

FIG. 8 is a schematic structural diagram of an encapsulation apparatus for a point cloud media file provided in an embodiment of this application.

FIG. 9 is a schematic structural diagram of a decapsulation apparatus for a point cloud media file provided in an embodiment of this application.

FIG. 10 is a schematic block diagram of an electronic device provided in an embodiment of this application.

### DESCRIPTION OF EMBODIMENTS

In conjunction with the drawings in the embodiments of the present disclosure, the technical solutions of the embodiments of the present disclosure will be clearly and completely described below. It is apparent that the embodiments described are only some, but not all embodiments of the present disclosure. Other embodiments can be obtained by those skilled in the art according to the embodiments of the present disclosure without creative work, which fall within the scope of protection of the present disclosure.

In the specification, claims, and the foregoing drawings of the present disclosure, the terms “first”, “second”, and the like are intended to distinguish between similar objects and not necessarily for describing a specific order or chronological order. It is to be understood that the data used accordingly is interchangeable under appropriate circumstances such that the embodiments of the present disclosure described herein can be implemented in a sequence other than those illustrated or described herein. Moreover, the terms “include” and “have”, and any variation thereof are intended to cover a non-exclusive inclusion. For example, a process, method, system, product, or server that comprises a list of steps or elements is not necessarily limited to those steps or elements expressly listed, but may include other steps or elements not expressly listed or inherent to such process, method, product, or device.

The embodiments of this application relate to a data processing technology for point cloud media.

Before the technical solutions of this application are introduced, the relevant knowledge of this application is described below.

Point Cloud: a point cloud is a set of discrete points which are randomly distributed in space and represent the spatial structure and surface attribute of a three-dimensional object or scene. Each point in the point cloud has at least three-dimensional position information, and may also have colour, material, or other information depending on the application scene. Typically, each point in the point cloud has the same number of additional attributes.

V3C Volumetric Media: visual volumetric video-based coding media refers to immersive media that captures three-dimensional spatial visual content and provides a 3DoF+ and 6DoF viewing experience. It is encoded with traditional video and comprises a volumetric video type track in file encapsulation, including multi-view video and video encoding point cloud.

PCC: Point Cloud Compression.

G-PCC: Geometry-based Point Cloud Compression.

V-PCC: Video-based Point Cloud Compression.

Atlas: indicating region information on a 2D plane frame, region information of 3D presentation space, a mapping relationship therebetween, and necessary parameter information required for mapping.

Track: a media data set during the media file encapsulation. A media file may be composed of a plurality of tracks. For example, a media file may comprise a video track, an audio track, and a subtitle track.

Sample: an encapsulation unit during the media file encapsulation. A media track is composed of many samples. A sample such as a video track is typically a video frame.

DoF: Degree of Freedom. In a mechanical system, it refers to the number of independent coordinates. In addition to translational DoF, there are rotational DoF and vibrational DoF. In the embodiments of this application, it refers to the movement supported and the DoF of content interaction produced by the user when viewing the immersive media.

3DoF: three degrees of freedom that refers to three degrees of freedom in which the user's head rotates of the X, Y, and Z axes. FIG. 1 shows a schematic illustration of 3DoF. As shown in FIG. 1, the user can rotate on three axes at a certain place or a certain point. The user can turn the head, nod the head up and down, or swing the head. Through a 3DoF experience, the user can be immersed in 360-degree view of a scene. If it is static, it can be understood as a panoramic picture. If the panoramic picture is dynamic, it is a panoramic video, i.e., a VR video. However, the VR video has some limitations, and the user cannot move and cannot select any place to see.

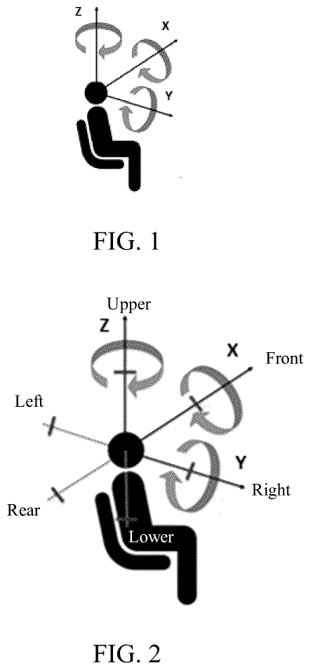

3DoF+: on the basis of 3DoF, the user also has the DoF to make limited movement along the X, Y, and Z axes, which can also be referred to as limited 6DoF, and the corresponding media bitstream can be referred to as limited 6DoF media bitstream. FIG. 2 shows a schematic illustration of 3DoF+.

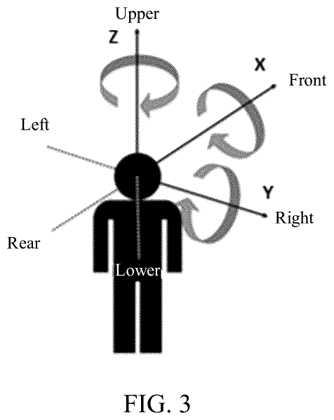

6DoF: on the basis of 3DoF, the user also has the DoF to move along the X, Y, and Z axes, and the corresponding media bitstream can be referred to as 6DoF media bitstream. FIG. 3 shows a schematic illustration of 6DoF. The 6DoF media refers to a 6DoF video, which means that the video can provide the user with a high-DoF viewing experience of freely moving a viewpoint in the directions of the X, Y, and Z axes in three-dimensional space and freely rotating the viewpoint around the X, Y, and Z axes. 6DoF media is a combination of videos with spatially diverse views collected by an array of cameras. In order to facilitate the expression, storage, compression, and processing of the 6DoF media, the 6DoF media data is expressed as a combination of the following information: a texture map collected by multiple cameras, a depth map corresponding to the texture map of the multiple cameras, and respective 6DoF media content description metadata, in which the metadata comprises parameters of the multiple cameras and description information such as splicing layout and edge protection of the 6DoF media. At the encoder side, texture map information and the corresponding depth map information of the multiple cameras are spliced, and the description data in the splicing method is written into the metadata according to the defined syntax and semantics. The spliced depth map and texture map information of the multiple cameras are encoded by planar video compression and are transmitted to a terminal for decoding. Then, the composition of 6DoF virtual viewpoints requested by the user is performed to provide the user with a viewing experience of the 6DoF media.

AVS: Audio Video Coding Standard.

ISOBMFF: International Standard Organization (ISO) Based Media File Format. ISOBMFF is the encapsulation standard for the media file. The most typical ISOBMFF file is the Moving Picture Experts Group 4 (MP4) file.

DASH: dynamic adaptive streaming over HTTP, which is an adaptive bit rate streaming technology that high-quality streaming media can be transferred over the Internet through the traditional HTTP network server.

MPD: media presentation description. MPD signaling in DASH is used for describing media segment information.

HEVC: High Efficiency Video Coding, HEVC/H.265.

VVC: versatile video coding, VVC/H.266.

Intra (picture) Prediction: intra picture prediction.

Inter (picture) Prediction: inter picture prediction.

SCC: screen content coding.

QP: Quantization Parameter.

Immersive media refers to the media content that can bring an immersive experience for users. Immersive media can be divided into 3DoF media, 3DoF+ media, and 6DoF media according to the DoF of the user when consuming the media content. The common 6DoF media includes point cloud media.

The point cloud is a set of discrete points which are randomly distributed in space and represent the spatial structure and surface attribute of the three-dimensional object or scene. Each point in the point cloud has at least three-dimensional position information, and may also have colour, material, or other information depending on the application scene. Typically, each point in the point cloud has the same number of additional attributes.

Because the point cloud can flexibly and conveniently represent the spatial structure and surface attribute of the three-dimensional object or scene, it is widely used in various field, including virtual reality (VR) game, computer aided design (CAD), geography information system (GIS), autonomous navigation system (ANS), digital cultural heritage, free viewpoint broadcasting, three-dimensional immersive remote presentation, three-dimensional reconstruction of biological tissue and organ.

The acquisition of point cloud mainly has the following ways: computer generating, 3D laser scanning, 3D photogrammetry, and the like. The computer can generate the point cloud of the virtual three-dimensional object and scene. 3D scanning can obtain the point cloud of static three-dimensional object or scene in the real world and can obtain millions of point clouds every second. 3D photography can obtain the point cloud of dynamic three-dimensional object or scene in the real world and can obtain tens of millions of point clouds every second. Furthermore, in the medical field, the point cloud of the biological tissue and organ can be obtained by MRI, CT, and electromagnetic position information. These technologies reduce the cost and time period of acquiring the point cloud data and improve the accuracy of the data. The transformation in the acquisition method of the point cloud data makes it possible to acquire a large number of point cloud data. With the continuous accumulation of large-scale point cloud data, efficient storage, transmission, distribution, sharing, and standardization of the point cloud data have become the key to point cloud application.

After the point cloud media is encoded, the encoded data stream needs to be encapsulated and transmitted to the user. Accordingly, at the point cloud media player side, the point cloud file needs to be firstly decapsulated, and then decoded. Finally, the decoded data stream is presented.

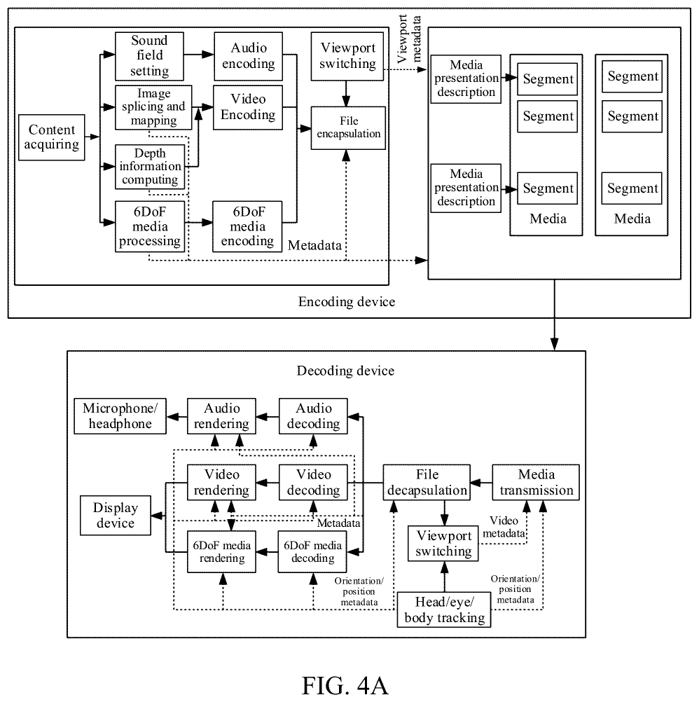

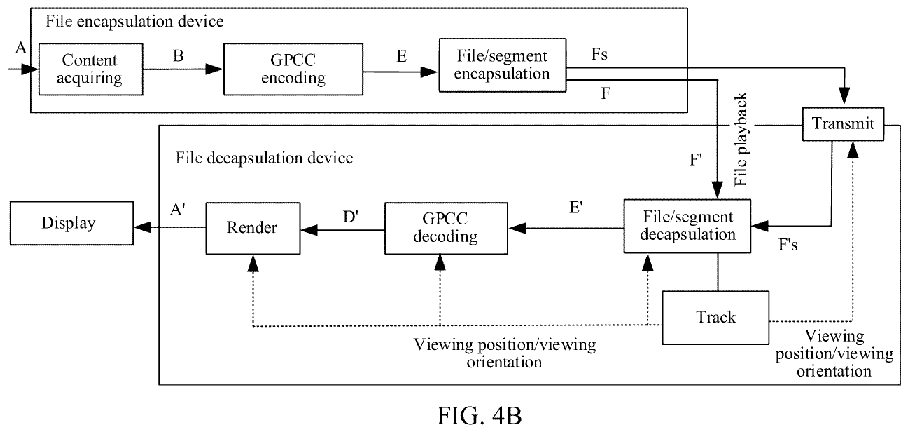

FIG. 4A is an architecture diagram of an immersive media system provided in an embodiment of this application. As shown in FIG. 4A, an immersive media system includes an encoding device and a decoding device. The encoding device may refer to a computer device used by a provider of immersive media. The computer device may be a terminal (e.g., personal computer (PC) and a smart mobile device (e.g., smart phone)) or a server. The decoding device may refer to a computer device used by a user of the immersive media. The computer device may be a terminal (e.g., personal computer (PC), a smart mobile device (e.g., smart phone), and a VR mobile device (e.g., VR helmet and VR glasses)). The data processing of the immersive media includes data processing at the encoding device side and data processing at the decoding device side.

The data processing at the encoding device side mainly includes:
(1) Acquisition and production of the media content of the immersive media;
(2) Encoding and file encapsulation of immersive media.

The data processing at the decoding device side mainly includes:
(3) File decapsulating and decoding of the immersive media;
(4) Rendering process of the immersive media.

In addition, the encoding device and the decoding device involve the transmission of the immersive media therebetween. The transmission can be performed based on various transmission protocols, and the transmission protocols herein may include, but are not limited to: Dynamic Adaptive Streaming over HTTP (Dash) protocol, HTTP Live Streaming (HLS) protocol, Smart Media Transport Protocol (SMTP), and Transmission Control Protocol (TCP).

Each process involved in the data processing of the immersive media is described in detail below with reference to FIG. 4A.

First, the data processing at the encoding device side:
(1) The acquisition and production of the media content of the immersive media;

1) The Acquisition of the Media Content of the Immersive Media.

The media content of the immersive media is obtained by collecting an audio-visual scene in the real world by a capture device.

In one embodiment, the capture device may be a hardware component provided in the encoding device, e.g., the capture device may include the microphone, camera, and sensor of the terminal. In another embodiment, the capture device may also include a hardware apparatus connected to the encoding device, such as a camera connected to the server.

The capture device may include, but is not limited to an audio device, a camera device, and a sensing device. The audio device may include an audio sensor and a microphone. The camera device may include a general camera, a stereo camera, and a light field camera. The sensing device may include laser device and radar device.

There may be a plurality of capture devices. These capture devices are deployed at specific positions in the real-world space to simultaneously capture the audio content and video content from different angles within the space. The captured audio content and video content are synchronized in both time and space. The media content collected by the capture device is referred to as raw data of the immersive media.

2) The Production of the Media Content of the Immersive Media.

The captured audio content is the content suitable for being subjected to audio encoding of the immersive media. The captured video content is subjected to a series of production flows before being suitable as the content for performing video encoding of the immersive media. The production flows may include the following steps.

A. Splice. Since the captured video contents are shot by the capture device at different angles, the splicing refers to splicing the video contents shot at these different angles into a complete video capable of reflecting a 360-degree visual panorama in the real space, namely, the spliced video is a panorama video (or a spherical video) represented in the three-dimensional space.

B. Project. Projection refers to the process of mapping a spliced three-dimensional (3D) video onto a two-dimensional (2D) image. The projected 2D image is referred to as a projected image. The methods of projection may include, but are not limited to longitudinal and latitudinal projection and hexahedral projection.

C. Region Encapsulate. The projected image may be encoded directly or after the projected image is region encapsulated. In practice, it is found that the video encoding efficiency of the immersive media can be greatly improved by region encapsulating and then encoding the 2D projected image during the data processing of the immersive media. Therefore, the region encapsulation technology is widely used in the video processing of the immersive media. The region encapsulation refers to the process of performing conversion processing on the projected image by region, and the process of region encapsulation causes the projected image to be converted into the encapsulated image. The process of region encapsulation specifically includes dividing a projected image into a plurality of mapping regions, performing conversion processing on the plurality of mapping regions separately to obtain a plurality of encapsulated regions, and mapping the plurality of encapsulated regions onto a 2D image to obtain an encapsulated image. The mapping region refers to a region divided in the projected image to be region encapsulated. An encapsulated region refers to a region in an encapsulated image after being subjected to the region encapsulation.

The conversion processing may include, but is not limited to mirroring, rotation, rearrangement, up-sampling, down-sampling, and changing the resolution and movement of the region.

Since only the panoramic video can be captured using the capture device, after such a video is processed by the encoding device and transmitted to the decoding device for corresponding data processing, the user at the decoding device side can only view 360-degree video information by performing some specific actions (such as head rotation). However, the user cannot obtain respective video changes by performing non-specific actions (such as moving the head), and thus a VR experience is poor. Therefore, it is necessary to additionally provide depth information matched with the panoramic video so as to enable the user to obtain a better immersive degree and a better VR experience. This involves the six degrees of freedom (6DoF) production technology. When the user can move more freely in the simulated scene, it is referred to as 6DoF. When the 6DoF production technology is used to produce the video content of the immersive media, a light field camera, a laser device, a radar device, and the like are generally selected as the capture device to capture point cloud data or light field data in the space. In addition, some specific processes need to be performed during the execution of the above production flows A-C, such as the process of cutting and mapping point cloud data, and the process of calculating depth information.

(2) Encoding and File Encapsulation of Immersive Media.

The captured audio content may be directly audio encoded to form an audio bitstream of the immersive media. After the above production flows A-B or A-C, video encoding is performed on the projected image or the encapsulated image to obtain a video bitstream of the immersive media, for example, encoding a packaged picture (D) into an encoded image (Ei) or an encoded video bitstream (Ev). The captured audio (Ba) is encoded into an audio bitstream (Ea). The encoded image, video, and/or audio are then combined into a media file for file playback (F) or a sequence of initialization segment and media segment for streaming (Fs) according to the specific media container file format. The encoding device side also includes metadata, such as the projection and region information, into the file or segment to aid in presenting the decoded packaged picture.

If the 6DoF production technology is used, a specific encoding mode (such as point cloud encoding) is required for encoding in the process of video encoding. Encapsulating the audio bitstream and the video bitstream in the file container based on the file format of the immersive media (such as ISO Base Media File Format (ISOBMFF)) to form a media file resource of the immersive media. The media file resource can be a media file or a media segment to form a media file of the immersive media. The media presentation description (MPD) is used to record the metadata of the media file resource of the immersive media based on the file format requirement of the immersive media. The metadata herein is a general term for information related to the presentation of the immersive media, and the metadata may include description information of media content, description information of a viewport, and signaling information related to the presentation of the media content. As shown in FIG. 4A, the encoding device may store the data processed MPD and media file resource.

The immersive media system supports an information box. The information box refers to a data block or object including metadata, i.e., the information box comprises the metadata of the respective media content. The immersive media may include a plurality of information boxes, for example including sphere region zooming box comprising the metadata for describing sphere region zooming information, 2D region zooming box comprising the metadata for describing 2D region zooming information, and region wise packing box comprising the metadata for describing respective information in the process of region encapsulation.

Second, the data processing at the decoding device side includes:

(3) File Decapsulating and Decoding of the Immersive Media;

The decoding device may adaptively and dynamically obtain the media file resource of the immersive media and the respective MPD from the encoding device by a recommendation of the encoding device or based on the requirements of the user at the decoding device side. For example, the decoding device may determine the orientation and position of the user according to the tracking information of the head/eye/body of the user. Then, the decoding device dynamically makes a request to obtain the respective media file resource to the encoding device based on the determined orientation and position. The media file resource and the MPD are transmitted by the encoding device to the decoding device via a transmission mechanism (e.g., DASH and SMT). The process of file decapsulation at the decoding device side is inverse to the process of file encapsulation at the encoding device side. The decoding device decapsulates the media file resource to obtain an audio bitstream and a video bitstream based on the file format requirement of the immersive media. The decoding process at the decoding device side is inverse to the encoding process at the encoding device side. The decoding device performs audio decoding on the audio bitstream and restores the audio content.

In addition, the process of decoding the video bitstream by the decoding device includes:

A. Decode a video bitstream to obtain a plane image. According to metadata provided by the MPD, if the metadata indicates that the immersive media has performed the process of region encapsulation, the plane image refers to an encapsulated image. If the metadata indicates that the immersive media has not performed the process of region encapsulation, the plane image refers to a projected image.

B. The decoding device performs region decapsulation on the encapsulated image to obtain a projected image, when the metadata indicates that the immersive media has performed the process of region encapsulation. The region decapsulation herein is inverse to the region encapsulation. The region decapsulation refers to a process of performing inverse conversion processing on the encapsulated image based on the region. The region decapsulation causes the encapsulated image to be converted into a projected image. The process of region decapsulation specifically includes performing inverse conversion processing on a plurality of encapsulated regions in the encapsulated image to obtain a plurality of mapping regions and mapping the plurality of mapping regions onto a 2D image to obtain a projected image based on the indication of the metadata. The inverse conversion processing refers to a process that is inverse to the conversion process. For example, if the conversion process refers to rotating by 90 degrees counterclockwise, then the inverse conversion processing refers to rotating by 90 degrees clockwise.

C. Reconstruct the projected image to convert it into a 3D image according to the MPD. The reconstruction herein refers to a processing of re-projecting the 2D projected image into a 3D space.

(4) The Rendering Process of Immersive Media.

The decoding device renders the audio content obtained by audio decoding and the 3D image obtained by video decoding according to metadata related to rendering and viewport in the MPD. The rendering is completed, i.e., the playing output of the 3D image is realized. Specifically, if the production technologies of 3DoF and 3DoF+ are used, the decoding device renders the 3D image mainly based on the current viewpoint, parallax, depth information, and the like. If the production technology of 6DoF is used, the decoding device renders the 3D image in the viewport mainly based on the current viewpoint. The viewpoint refers to a viewing position point of the user. The parallax refers to a sight disparity caused by binocular vision of the user, or a sight disparity caused by the movement. The viewport refers to a viewing region.

The immersive media system supports an information box. The information box refers to a data block or object including metadata, i.e., the information box comprises the metadata of the respective media content. The immersive media may include a plurality of information boxes, for example including sphere region zooming box comprising the metadata for describing sphere region zooming information, 2D region zooming box comprising the metadata for describing 2D region zooming information, and region wise packing box comprising the metadata for describing respective information in the process of region encapsulation.

FIG. 4B is a content flowchart of GPCC point cloud media provided in an embodiment of this application. As shown in FIG. 4B, the immersive media system includes a file encapsulator and a file decapsulator. In some embodiments, the file encapsulator may be understood as the encoding device described above, and the file decapsulator may be understood as the decoding device described above.

A visual scene in the real world (A) is captured by a set of cameras or camera devices with multiple lenses and sensors. The collected result is source point cloud data (B). One or more point cloud frames are encoded into a G-PCC bitstream, including an encoded geometry bitstream and an attribute bitstream (E). One or more encoded bitstreams are then combined into a media file for file playback (F) or a sequence of initialization segment and media segment for streaming (Fs) according to the specific media container file format. In this application, the media container file format is the ISOBMFF specified in ISO/IEC 14496-12. The file encapsulator also comprises metadata into the file or segment. The segment Fs is delivered to the player using a delivery mechanism.

The file (F) output by the file encapsulator is the same as the file (F′) inputted by the file decapsulator. The file decapsulator processes the file (F′) or the received segment (F′s), extracts the encoded bitstream (E′), and parses the metadata. The G-PCC bitstream is then decoded into a decoded signal (D′), and point cloud data is generated from the decoded signal (D′). Where applicable, the point cloud data is rendered and displayed on the screen of a head-mounted display or any other display device, and tracked according to the current viewing position, viewing direction, or viewport determined by various types of sensors (e.g., head). The tracking may use a position tracking sensor or an eye movement tracking sensor. In addition to being used by the player to access an appropriate portion of the decoded point cloud data, the current viewing position or viewing direction may also be used for optimizing the decoding. In viewport dependent transferring, the current viewing position and viewing direction are also transferred to a policy module (not shown) for deciding the track to be received or decoded.

The above process applies to real-time and on-demand use cases.

The parameters in FIG. 4B are defined as follows:
E/E′: coded G-PCC bitstream;
F/F′: a media file including a track format specification, possibly comprising a constraint on elementary stream comprised in the track sample.

Each point in the point cloud includes geometry information and attribute information. The attribute information includes different types of attribute information, such as colour attribute and reflectance. The same type of attribute information may also include different attribute instances. An attribute instance is a concrete instance of an attribute in which the value of the attribute is specified. For example, the colour attribute of a point includes different colour types, and the different colour types are referred to as different attribute instances of the colour attribute. In encoding technologies, such as geometry-based point cloud compression (GPCC), multiple attribute instances of the same attribute type comprised in a bitstream are supported, and the multiple attribute instances of the same attribute type can be distinguished by attribute instance id.

However, although the current point cloud media encapsulation technology, such as the GPCC encoding technology, supports multiple attribute instances of the same attribute type to exist simultaneously in a bitstream, it does not have a corresponding information indication. As a result, the file decapsulation device cannot determine which attribute instance is specifically requested.

In order to improve at least one aspect of the point cloud media encapsulation technology, in the process of encapsulating a media file, the file encapsulation device of an embodiment of this application adds the first feature information of at least one attribute instance of M attribute instances of the same type of attribute information of the target point cloud to the media file. Accordingly, the file decapsulation device can determine the target attribute instance to be specifically decoded according to the first feature information of the attribute information, thereby saving broadband and decoding resources and improving the decoding efficiency.

The technical solutions of the embodiments of this application are described in detail below by some embodiments. The several embodiments below may be combined with each other, and the same or similar concepts or processes may not be repeated in some embodiments.

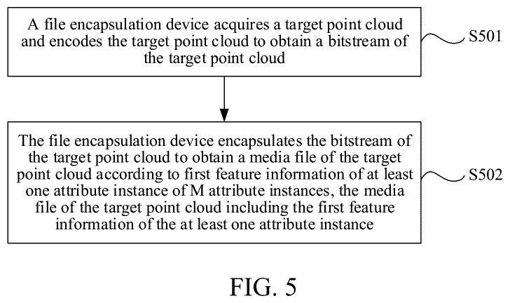

FIG. 5 is a flowchart of an encapsulation method for a point cloud media file provided in an embodiment of this application. As shown in FIG. 5, the method includes the following steps:

S501: A file encapsulation device acquires a target point cloud and encodes the target point cloud to obtain a bitstream of the target point cloud.

In some embodiments, the file encapsulation device is also referred to as a point cloud encapsulation device or a point cloud encoding device.

In an example, the target point cloud is a complete point cloud.

In another example, the target point cloud is part of the complete point cloud, for example a subset of the complete point cloud.

In some embodiments, the target point cloud is also referred to as target point cloud data, or target point cloud media content, or target point cloud content, and the like.

In an embodiment of this application, the methods that the file encapsulation device acquires the target point cloud include but are not limited to the following several methods.

Method one: The file encapsulation device acquires the target point cloud from the point cloud collection device. For example, the file encapsulation device acquires the point cloud collected by the point cloud collection device as the target point cloud from the point cloud collection device.

Method two: The file encapsulation device acquires the target point cloud from the storage device. For example, after the point cloud data is collected by the point cloud collection device, the point cloud data is stored in the storage device, and the file encapsulation device acquires the target point cloud from the storage device.

Method three: The file encapsulation device performs block division on the complete point cloud and takes one block thereof as the target point cloud after acquiring the complete point cloud according to the above method one or method two, when the above target point cloud is a local point cloud.

In an embodiment of this application, the target point cloud includes N types of attribute information, and at least one type of attribute information of the N types of attribute information includes M attribute instances, where the N is a positive integer, and the M is a positive integer greater than 1. The target point cloud includes instance data corresponding to the M attribute instances, for example, instance data of an attribute instance with an attribute value of Al of an attribute type A.

For example, the target point cloud includes N types of attribute information, such as colour attribute, reflectance attribute, and transparency attribute. The colour attribute includes different M attribute instances, for example, the colour attribute includes a blue attribute instance and a red attribute instance.

The above acquired target point cloud is encoded to obtain a bitstream of the target point cloud. In some embodiments, the encoding of the target point cloud includes encoding the geometry information and the attribute information of the point cloud separately to obtain a geometry bitstream and an attribute bitstream of the point cloud. In some embodiments, the geometry information and the attribute information of the target point cloud are encoded simultaneously, and the obtained point cloud bitstream includes the geometry information and the attribute information.

An embodiment of this application mainly relates to the encoding of the attribute information of the target point cloud.

S502: The file encapsulation device encapsulates the bitstream of the target point cloud to obtain a media file of the target point cloud according to first feature information of at least one attribute instance of M attribute instances. The media file of the target point cloud includes the above first feature information of at least one attribute instance.

In various embodiments, the file encapsulation device can encapsulate the first feature information of at least one attribute instance of M attribute instances in the media file of the target point cloud as metadata of instance data corresponding to the at least one attribute instance, when the target point cloud includes the instance data corresponding to the M attribute instances of at least one type of attribute information. The first feature information is used for identifying a difference between the at least one attribute instance and other attribute instances of the above M attribute instances except the at least one attribute instance. Hereinafter, “instance data corresponding to an attribute instance” is simply referred to as “an attribute instance”.

The first feature information of the attribute instance can be understood as information for identifying that the attribute instance is different from other attribute instances of the M attribute instances, for example, priority and identification of the attribute instance.

The concrete content of the first feature information of the attribute instance is not limited to the embodiments of this application.

In some embodiments, the first feature information of the attribute instance includes: at least one of an identification of the attribute instance, a priority of the attribute instance, and a type of the attribute instance.

In an example, the identification of the attribute instance is represented by the filed attr_instance_id, and different values of the field represent identification values of the attribute instance.

In an example, the priority of the attribute instance is represented by the field attr_instance_priority. In some embodiments, the smaller the value of the field is, the higher the priority of the attribute instance is.

In some embodiments, the attr_instance_id may be multiplexed to indicate the priority of the attribute instance. For example, the smaller the value of the attr_instance_id is, the higher the priority of the attribute instance is.

In an example, the type of the attribute instance, also referred to as selection policy of the attribute instance, is represented by the field attr_instance_type, and different values of the field represent different types of the attribute instances.

The type of the attribute instance can be understood as a policy for indicating the file decapsulation device to select a target attribute instance from M attribute instances of the same type. Alternatively, it can be understood as a consumption scene for indicating different attribute instances. For example, the consumption scene of the attribute instance is that the attribute instance is associated with scene 1. Accordingly, the file decapsulation device under scene 1 can request the attribute instance associated with the scene 1, thereby obtaining instance data of the attribute instance associated with the scene 1.

In some embodiments, the type of the attribute instance includes at least one of an attribute instance associated with a recommendation viewport and an attribute instance associated with user feedback.

For example, if the type of the attribute instance is the attribute instance associated with the user feedback, the file decapsulation device can determine the attribute instance associated with the user feedback information according to the user feedback information, and then the attribute information can be determined as the target attribute instance to be decoded.

As another example, if the type of the attribute instance is the attribute instance associated with the recommendation viewport, the file decapsulation device can determine the attribute instance associated with the recommendation viewport according to the information related to the recommendation viewport, and then the attribute instance can be determined as the target attribute instance to be decoded.

In some embodiments, if the value of the field attr instance type is the first numerical value, it indicates that the type of the attribute instance is the attribute instance associated with the recommendation viewport.

In some embodiments, if the value of the field attr_instance_type is the second numerical value, it indicates that the type of the attribute instance is the attribute instance associated with the user feedback. Exemplarily, the value of the field attr_instance_type is as shown in Table 1:

TABLE 1

| attr_instance_type Value | Description |
|---|---|
| First numerical value | Instance associated with viewport |
| Second numerical value | Instance associated with user feedback |
| Else | Reserved |

In some embodiments, the first numerical value is 0.

In some embodiments, the second numerical value is 1.

The above is merely an example of the first numerical value and the second numerical value, and the values of the first numerical value and the second numerical value include but are not limited to the above 0 and 1. The values are determined based on specific scenarios.

In this step, the above first feature information of at least one attribute instance of M attribute instances belonging to the same type of attribute information is added to the media file of the target point cloud.

The specific adding position of the above first feature information of at least one attribute instance in the media file is not limited in the embodiments of this application, for example, the first feature information may be added to the head sample of the track corresponding to at least one attribute instance.

In some embodiments, the above implementation process of the encapsulating the bitstream of the target point cloud to obtain a media file of the target point cloud according to first feature information of at least one attribute instance of the M attribute instances in S502 (i.e., adding the first feature information of at least one attribute instance of M attribute instances to the media file of the target point cloud) includes the following several cases.

In case 1, the first feature information of at least one attribute instance is added to a sub-sample information box corresponding to the M attribute instances, when geometry information and attribute information of a frame of point cloud in the target point cloud are encapsulated in a track or an item.

In case 1, when the target point cloud is encapsulated, the encapsulation of the point cloud bitstream is performed on the encapsulation unit based on a point cloud frame. A frame of point cloud can be understood as the point cloud scanned by the point cloud collection device during one scanning process. Alternatively, a frame of point cloud is a point cloud of a pre-set size. During the encapsulation, when the geometry information and attribute information of a frame of point cloud are encapsulated in a track or an item, the track or item includes a sub-sample of the geometry information and a sub-sample of the attribute information. The first feature information of at least one attribute instance is added to the sub-sample information box corresponding to the M attribute instances.

In an example, if N types of attribute information of the target point cloud are encapsulated in a sub-sample, then the first feature information of at least one attribute instance may be added to the sub-sample information box.

In another example, if each attribute information of the N types of attribute information of the target point cloud is encapsulated in a sub-sample, and the above M attribute instances are attribute instances of an a^{th} type of attribute information, then the first feature information of at least one attribute instance of M attribute instances may be added to the sub-sample information box of the a^{th} type of attribute information.

In some embodiments, if the encapsulation standard of the above media file is ISOBMFF, the data structure of the sub-sample information box corresponding to the above case 1 is as follows.

The field codec_specific_parameters in the sub-sample information box is defined as follows:

```
if (flags == 0) {
  unsigned int(8) payloadType;
  if (payloadType == 4) { // attribute payload
    unsigned int(6) attrIdx;
    unsigned int(1) multi_attr_instance_flag;
      if (multi_attr_instance_flag)
      {
        unsigned int(8) attr_instance_id;
        unsigned int(4) attr_instance_priority;
        unsigned int(4) attr_instance_type;
        bit(1) reserved;
      }
      else{
        bit(17) reserved = 0;
      }
  }
  else
    bit(24) reserved = 0;
}
```

The payloadType is used to indicate the data type tlv_type of G-PCC unit in the sub-sample.

The attrldx is used to indicate the ash_attr_sps_attr_idx of the G-PCC unit comprising attribute data in the sub-sample.

That the value of the multi_attr_instance_flag is 1 indicates that there are multiple attribute instances of the attribute of the current type. The value of 0 indicates that there is only one attribute instance of the attribute of the current type.

The attr_instance_id indicates the identifier of the attribute instance.

The attr_instance_priority indicates the priority of the attribute instance, and the smaller the value of the field is, the higher the priority of the attribute instance is. When there are multiple attribute instances in one attribute type, the client side may discard low priority attribute instances.

The attr_instance_type indicates the type of the attribute instance, the field is used to indicate consumption scenes of different instances, and the value of the meaning of the field is as follows:

| attr_instance_type Value | Description |
|---|---|
| 0 | Instance associated with viewport |
| 1 | Instance associated with user feedback |
| Else | Reserved |

In case 1, after obtaining the media file, the file decapsulation device may obtain the first feature information of at least one attribute instance of M attribute instances from the above sub-sample information box, and then determine a target attribute instance to be decoded according to the first feature information, thereby avoiding decoding all the attribute instances and improving the decoding efficiency.

In case 2, the first feature information of the at least one attribute instance is added to a component information box corresponding to the M attribute instances, when each attribute information of the M attribute instances is encapsulated in a track or an item.

In case 2, when the target point cloud is encapsulated, the geometry information and attribute information of a frame of point cloud are encapsulated separately. For example, the geometry information is encapsulated in a geometry track, and each attribute instance of each type of attribute information of N types of attribute information is encapsulated in a track or an item. Specifically, when each attribute instance of the M attribute instances belonging to the same type of attribute information is encapsulated in a track or an item, the above first feature information of at least one attribute instance may be added to the component information box corresponding to the M attribute instances.

In some embodiments, if the encapsulation standard of the above media file is ISOBMFF, the data structure of the component information box corresponding to the above case 2 is as follows:

```
aligned(8) class GPCCComponentInfoBox extends
FullBox(′ginf′, version = 0, 0) {
  unsigned int(8) gpcc_type;
  if(gpcc_type == 4) {
      unsigned int(8) attr_index;
      unsigned int(1) attr_type_present_flag;
      unsigned int(1) multi_attr_instance_flag;
      bit(3) reserved = 0;
      if (attr_type_present_flag)
      {
        unsigned int(3) attr_type;
      } else {
        bit(3) reserved = 0;
      }
      if (multi_attr_instance_flag)
      {
        unsigned int(8) attr_instance_id;
        unsigned int(4) attr_instance_priority;
        unsigned int(4) attr_instance_type;
      }
      utf8string attr_name;
    }
}
```

The gpcc_type is used to indicate the type of GPCC composition, and its value meaning is shown in Table 2.

TABLE 2
Component Type

| gpcc_type Value | Description |
|---|---|
| 1 | Reserved |
| 2 | Geometry data |
| 3 | Reserved |
| 4 | Attribute data |
| 5 . . . 31 | Reserved |

The attr_index is used to indicate the sequence number of the attribute indicated in the sequence parameter set (SPS).

That the value of the attr_type_present_flag is 1 indicates that the attribute type information is indicated in the GPCCComponentInfoBox information box. The value of 0 indicates that no attribute type information is indicated in the information box GPCCComponentInfoBox.

The attr_type indicates the type of the attribute composition, and its value is shown in Table 3.

TABLE 3

| Four bytes of attribute information | |
|---|---|
| (attribute_label_four_bytes[i]) | Attribute type |
| 0 | Colour |
| 1 | Reflectance |
| 2 | Frame index |
| 3 | Material ID |
| 4 | Transparency |
| 5 | Normals |
| 6 . . . 255 | Reserved |
| 256 . . . 0xffffffff | Unspecified |

The attr_name is used to indicate human-readable attribute composition type information.

That the value of the multi_attr_instance_flag is 1 indicates that there are multiple attribute instances of the attribute of the current type. The value of 0 indicates that there is only one attribute instance of the attribute of the current type.

The attr_instance_id indicates the identifier of the attribute instance.

The attr_instance_priority indicates the priority of the attribute instance, and the smaller the value of the field is, the higher the priority of the attribute instance is. When there are multiple attribute instances in one attribute type, the client side may discard low priority attribute instances.

In some embodiments, the attr_instance_id may be multiplexed to indicate the priority of the attribute instance. The smaller the value of the attr_instance_id is, the higher the priority of the attribute instance is.

The attr_instance_type indicates the type of the attribute instance, the field is used to indicate consumption scenes of different instances, and the value of the meaning of the field is as follows:

| attr_instance_type Value | Description |
|---|---|
| 0 | Instance associated with viewport |
| 1 | Instance associated with user feedback |
| Else | Reserved |

In case 2, after obtaining the media file, the file decapsulation device may obtain the first feature information of at least one attribute instance of M attribute instances from the above component information box, and then determine a target attribute instance to be decoded according to the first feature information, thereby avoiding decoding all the attribute instances and improving the decoding efficiency.

In an example of case 2, M attribute instances belonging to the same type of attribute information may be encapsulated in M tracks or items on a one-to-one basis. One track or item includes one attribute instance so that the first feature information of the attribute instance may be directly added to the information box of the track or item corresponding to the attribute instance.

In case 3, the first feature information of the at least one attribute instance of M attribute instances is added to the above track group box or entity group box, when each attribute instance of the M attribute instances is encapsulated in a track or an item, and M tracks corresponding to the M attribute instances constitute the track group, or M items corresponding to the M attribute instances constitute the entity group.

For example, each attribute instance of the M attribute instances of the same type of attribute information is encapsulated in a track, resulting in M tracks that constitute a track group. Accordingly, the above first feature information of at least one attribute instance of M attribute instances can be added to the track group box (AttributeinstanceTrackGroupBox).

As another example, each attribute instance of the M attribute instances of the same type of attribute information is encapsulated in an item, resulting in M items that constitute an entity group. Accordingly, the above first feature information of at least one attribute instance of M attribute instances can be added to the entity group box (AttributeInstanceEntityToGroupBox).

The adding position of the first feature information in the media file of the target point cloud includes but is not limited to the above 3 cases.

In some embodiments, when the type of the attribute instance is the attribute instance associated with the recommendation viewport, the method of this application further includes S502-1.

S502-1: The file encapsulation device adds second feature information of the attribute instance to a metadata track of the recommendation viewport associated with the attribute instance.

In an example, the second feature information of the attribute instance is consistent with the first feature information of the attribute instance, including at least one of the identification of the attribute instance, the priority of the attribute instance, and the type of the attribute instance.

In another example, the second feature information of the attribute instance includes at least one identification of the attribute instance and an attribute type of the attribute instance. For example, the second feature information of the attribute instance includes the identification of the attribute instance. As another example, the second feature information of the attribute instance includes the identification of the attribute instance and the attribute type of the attribute instance.

In some embodiments, the adding second feature information of the attribute instance to a metadata track of the recommendation viewport associated with the attribute instance may be achieved by the following procedure:

```
aligned(8) class ViewportInfoSample( ) {
  unsigned int(8) num_viewports;
  for (i=1; i <= num_viewports; i++){
  unsigned int(7) viewport_id[i];
  unsigned int(1) viewport_cancel_flag[i];
  if (viewport_cancel_flag[i] == 0) {
    unsigned int(1) camera_extrinsic_flag[i];
    unsigned int(1) camera_intrinsic_flag[i];
    unsigned int(1) attr_instance_asso_flag[i];
    bit(4) reserved = 0;
    ViewportInfoStruct(camera_extrinsic_flag[i], camera_intrinsic_flag[i]);
  }
    if(attr_instance_asso_flag[i]){
unsigned int(3) attr_type;
unsigned int(8) attr_instance_id;
bit(5) reserved;
}
  }
}
```

If the viewport information metadata track exists, the camera extrinsic parameter information ExtCameraInfoStruct( ) is to appear in the sample entry or in the sample. The following cases are not to occur: the value of dynamic_ext_camera_flag is 0 and the value of camera_extrinsic_flag[i] in all samples is 0.

The num_viewports indicate the number of viewports indicated in the sample.

The viewport_id[i] indicates the identifier of the corresponding viewport.

That the value of the viewport_cancel_flag[i] is 1 indicates that a viewport with the value of a viewport identifier of viewport_id[i] is cancelled.

That the value of the camera_intrinsic_flag[i] is 1 indicates that there is a camera intrinsic parameter in an i^{th} viewport in the current sample. If the value of dynamic_int_camera_flag is 0, the value of the field is 0. Meanwhile, when the value of the camera_extrinsic_flag[i] is 0, the value of the field is 0.

That the value of the camera_extrinsic_flag[i] is 1 indicates that there is a camera extrinsic parameter in the i^{th} viewport in the current sample. If the value of the dynamic_ext_camera_flag is 0, the value of the field is 0.

That the value of the attr_instance_asso_flag[i] is 1 indicates that the i^{th} viewport in the current sample is associated with the corresponding attribute instance. When the value of the attr_instance_type is 0, the value of the attr_instance_asso_flag in at least one sample in the current track is 1.

The attr_type indicates the type of the attribute composition, and its value is shown in the above Table 3.

The attr_instance_id indicates the identifier of the attribute instance.

In an embodiment of this application, the second feature information of the attribute instance is added to a metadata track of the recommendation viewport associated with the attribute instance, when the type of the attribute instance is the attribute instance associated with the recommendation viewport. Accordingly, having requested the metadata track of the recommendation viewport, the file decapsulation device determines the target attribute instance to be decoded according to the second feature information of the attribute instance added to the metadata track of the recommendation viewport. For example, the second feature information includes the identification of the attribute instance, and the file decapsulation device can transmit the identification of the attribute instance to the file encapsulation device such that the file encapsulation device transmits the media file of the attribute instance corresponding to the identification of the attribute instance to the file decapsulation device for consumption. It avoids the file decapsulation device requesting unnecessary resources, thereby saving bandwidth and decoding resources and improving the decoding efficiency.

In some embodiments, the file encapsulation device links tracks of the M attribute instances by a track group box, when the M attribute instances are encapsulated in the tracks of the M attribute instances on a one-to-one basis.

Specifically, M attribute instances are encapsulated in the tracks of the M attribute instances on a one-to-one basis, one track of the attribute instance includes one attribute instance, and M attribute instances belonging to the same type of attribute information can be linked.

Exemplarily, using a track group to link the tracks of different attribute instances of the same attribute type may be achieved by adding the identification of M attribute instances to the track group box.

In some embodiments, the linking tracks of the M attribute instances by a track group box can be achieved by the following procedure:

```
Attribute instance track group
Information box type: ′paig′
Comprised in: TrackGroupBox
Mandatory: Non-mandatory
Number: 0 or more
aligned(8) class AttributeInstanceTrackGroupBox extends TrackGroupTypeBox(′paig′) {
  // track_group_id is inherited from TrackGroupTypeBox
    unsigned int(4) attr_type;
  unsigned int(4) attr_instance_priority;
unsigned int(8) attr_instance_id;
}
```

The attr_type indicates the type of the attribute composition, and its value is shown in Table 3.

The attr_instance_id indicates the identifier of the attribute instance.

The attr_instance_priority indicates the priority of the attribute instance, and the smaller the value of the field is, the higher the priority of the attribute instance is. When there are multiple attribute instances in one attribute type, the client side may discard low priority attribute instances.

In some embodiments, items of the M attribute instances are linked by an entity group box, when the M attribute instances are encapsulated in the items of the M attribute instances on a one-to-one basis.

Specifically, the M attribute instances are encapsulated in the items of the M attribute instances on a one-to-one basis, one item of the attribute instance includes one attribute instance, and M attribute items belonging to the same type of attribute information can be linked.

Exemplarily, using an entity group to link the items of different attribute instances of the same attribute type may be achieved by adding the identification of M attribute instances to the entity group box.

In some embodiments, the linking tracks of the M attribute instances by an entity group box can be achieved by the following procedure:

```
Attribute instance entity to group
Information box type: ′paie′
Comprised in: GroupsListBox
Mandatory: Non-mandatory
Number: 0 or more
aligned(8) class AttributeInstanceEntityToGroupBox extends
EntityToGroupBox (′paie′) {
    unsigned int(32) group_id;
    unsigned int(32) num_entities_in_group;
    for(i=0; i<num_entities_in_group; i++){
      unsigned int(4) attr_type;
      unsigned int(4) attr_instance_priority;
unsigned int(8) attr_instance_id;
  }
}
```

The attr_type indicates the type of the attribute composition, and its value is shown in Table 3.

The attr_instance_id indicates the identifier of the attribute instance.

The attr_instance_priority indicates the priority of the attribute instance, and the smaller the value of the field is, the higher the priority of the attribute instance is. When there are multiple attribute instances in one attribute type, the client side may discard low priority attribute instances.

An encapsulation method for a point cloud media file provided in an embodiment of this application includes: acquiring a target point cloud and encoding the target point cloud to obtain a bitstream of the target point using a file encapsulation device, the target point cloud including N types of attribute information, at least one type of attribute information of the N types of attribute information including M attribute instances, the N being a positive integer, and the M being a positive integer greater than 1; encapsulating the bitstream of the target point cloud to obtain a media file of the target point cloud according to first feature information of at least one attribute instance of the M attribute instances, the media file of the target point cloud including the first feature information of the at least one attribute instance. In this application, the first feature information of the attribute instance is added to the media file such that the file decapsulation device can determine the target attribute instance to be specifically decoded according to the first feature information of the attribute information, thereby saving broadband and decoding resources and improving the decoding efficiency.

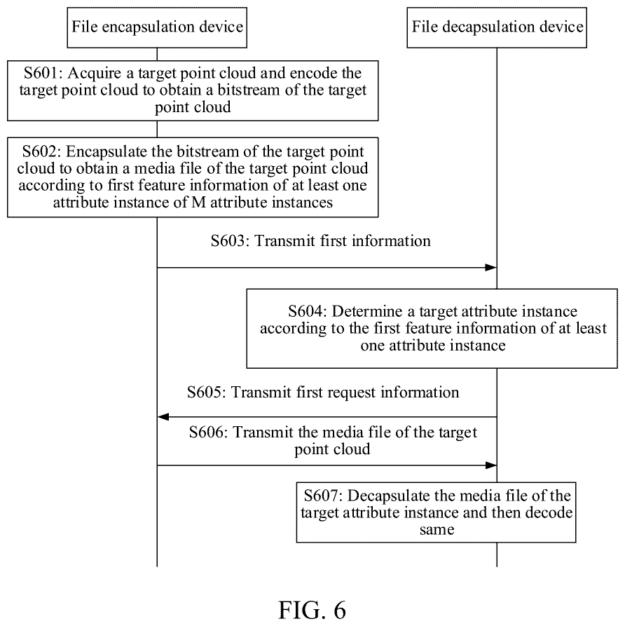

FIG. 6 is a flowchart of interactive encapsulation and decapsulation methods for a point cloud media file provided in an embodiment of this application. As shown in FIG. 6, this embodiment includes the following steps:

S601: A file encapsulation device acquires a target point cloud and encodes the target point cloud to obtain a bitstream of the target point cloud.

The target point cloud includes N types of attribute information, and at least one type of attribute information of the N types of attribute information includes M attribute instances, where the N is a positive integer, and the M is a positive integer greater than 1.

S602: The file encapsulation device encapsulates the bitstream of the target point cloud to obtain a media file of the target point cloud according to first feature information of at least one attribute instance of the M attribute instances, the media file of the target point cloud including the first feature information of the at least one attribute instance.

The above S601 and the above S602 can be implemented as described in the detailed description of the above S501 to the above S502, which will not be repeated herein.

The file encapsulation device encodes and encapsulates the target point cloud according to the above steps. After obtaining the media file of the target point cloud, the file encapsulation device can perform data interaction with the file decapsulation device in the following several methods:

Method one: The file encapsulation device can directly transmit the encapsulated media file of the target point cloud to the file decapsulation device such that the file decapsulation device selectively consumes some attribute instances according to the first feature information of the attribute instances in the media file.

Method two: The file encapsulation device transmits a signaling to the file decapsulation device, and the file decapsulation device requests all or part of the media files of the attribute instances to consume to the file encapsulation device according to the signaling.

In this embodiment, the process that the file decapsulation device requests part of the media files of the attribute instances to consume in method two is described, with specific reference to the following S603 to step.

S603: The file encapsulation device transmits the first information to a file decapsulation device.

The first information is used for indicating the first feature information of the at least one attribute instance of the M attribute instances.

The first feature information of the attribute instance includes at least one of an identification of the attribute instance, a priority of the attribute instance, and a type of the attribute instance.

In some embodiments, the above first information is DASH signaling.

In some embodiments, if the above first information is DASH signaling, the semantic description of the DASH signaling is as shown in Table 4:

TABLE 4

| Element and attribute | | | |
|---|---|---|---|
| descriptor for GPCC | | | |
| component | Use | Data type | Description |
| component@component_type | 0 . . . N | gpcc: gpcc | An element whose attributes specify |
| | | component | information for one of the Geometry point |
| | | type | cloud components present in the |
| | | | representation(s) of the adaptation set. |
| component@attribute_type | M | xs: string | Indicates the type of the point cloud |
| | | | component. The value ‘geom’ indicates |
| | | | a G-PCC geometry component, and ‘attr’ |
| | | | indicates a G-PCC attribute component. |
| component@attr_index | CM | xs: | Indicates the type of the attribute. Only values |
| | | unsigned | between 0 and 255, inclusive, are allowed. |
| | | byte | Shall be present only if the component is a G- |
| | | | PCC attribute (i.e. @component_type has the |
| | | | value ‘attr’). |
| component@attr_instance_id | CM | xs: | Indicates the order of the attribute present in |
| | | unsigned | the SPS. The value of @attr_index shall be |
| | | byte | identical to the ash_attr_sps_attr_idx value of |
| | | | G-PCC units carried by the Representations |
| | | | of the Adaptation Set. Shall be present only if |
| | | | the component is a point cloud attribute (i.e., |
| | | | @component_type has the value ‘attr’). |
| component@attr_instance_type | O | xs: | Indicates the identifier of the attribute |
| | | unsigned | instance. |
| | | byte | |
| component@attr_instance_priority | O | xs: | Indicates the type of the attribute instance. |
| | | unsigned | |
| | | byte | |
| component@tile_ids | O | xs: | Indicate the priority of the attribute instance. |
| | | unsigned | The smaller the value of the field is, the |
| | | byte | higher the priority of the attribute instance is. |
| | | | When there are multiple attribute instances in |
| | | | one attribute type, the client side may discard |
| | | | low priority attribute instances. (In some |
| | | | embodiments, the attr_instance_id may be |
| | | | multiplexed to indicate the priority of the |
| | | | attribute instance. The smaller the value of |
| | | | the attr_instance_id is, the higher the priority |
| | | | of the attribute instance is.) |
| component@component_type | CM | xs: U | A list of space-separated identifiers |
| | | integer | corresponding to the value of the tile_id field |
| | | vector type | of each G-PCC tile present in the G-PCC tile |
| | | | track. |
| | | | Shall only be present if the Adaption Set is a |
| | | | Tile Component Adaptation Set. |
| | | | Shall only be present if the corresponding tile |
| | | | track carries a constant number of tiles |
| | | | and the tile identifiers do not change |
| | | | throughout the bitstream. i.e., |
| | | | dynamic_tile_flag is set to 0 in the |
| | | | GPCCTileSampleEntry of the respective tile |
| | | | track. |

For the attribute: M = mandatory, O = optional, OD = optional with default value, and CM = conditionally mandatory
For the element: <Minimum Occurrence> . . . <Maximum Occurrence> (N = non-bounded)
The element in bold; The attribute is not bold and begin with @.

The above Table 4 is a form of the first information, and the first information of the embodiments of this application includes but is not limited to the contents shown in the above Table 4.

The first feature information of the attribute instance includes at least one of an identification of the attribute instance, a priority of the attribute instance, and a type of the attribute instance.

In some embodiments, the above first information is DASH signaling.

S604: The file decapsulation device determines a target attribute instance according to the first feature information of at least one attribute instance.

The file decapsulation device determines the target attribute instance from the at least one attribute instance using the first feature information to acquire instance data corresponding to the target attribute instance.

In this step, the methods that the file decapsulation device determines the target attribute instance according to the first feature information of at least one attribute instance indicated by the first information include but are not limited to the following several methods:

Method one: One or more attribute instances with a high priority may be determined as the target attribute instance, when the first feature information of the attribute instance includes the priority of the attribute instance.

Method two: One or more attribute instances may be selected and determined as the target attribute instances according to the identification of the attribute instance, when the first feature information of the attribute instance includes the identification of the attribute instance, and the identification of the attribute instance is used to represent the priority of the attribute instance. For example, if a smaller attribute instance identification indicates a higher priority, then one or more attribute instances with the smallest identification may be determined as the target attribute instance. As another example, if a bigger identification of the attribute instance indicates a higher priority, then one or more attribute instances with the biggest identification may be determined as the target attribute instance.

Method three: The target attribute instance may be determined from at least one attribute instance according to the type of the attribute instance, when the first feature information of the attribute instance includes the type of the attribute instance, then, with specific reference to the following example one and example two.

Example one: the file decapsulation device determines the target attribute instance from the at least one attribute instance according to the first feature information of the at least one attribute instance of M pieces of attribute information, when the type of the attribute instance is an attribute instance associated with user feedback.

For example, the target attribute instance is determined from the at least one attribute instance according to the network bandwidth and/or device computation of the file decapsulation device and the priority of the attribute instance in the first feature information. Exemplarily, if the network bandwidth is sufficient and the device computation is strong, more attribute instances in at least one attribute instance may be determined as the target attribute instance. If the network bandwidth is insufficient, and/or the device computation is weak, the attribute instance with the highest priority of at least one attribute instance may be determined as the target attribute instance.

Example two, the file decapsulation device acquires a metadata track of a recommendation viewport, when the type of the attribute instance is an attribute instance associated with the recommendation viewport, and determines the target attribute instance from the at least one attribute instance of the M pieces of attribute information according to second feature information of an attribute instance included in the metadata track of the recommendation viewport.

In some embodiments, the second feature information of the attribute instance includes at least one of an identification of the attribute instance and an attribute type of the attribute instance.

The file decapsulation device acquires the metadata track of the recommendation viewport in the following methods. The file encapsulation device transmits second information to the file decapsulation device, the second information being used for indicating the metadata track of the recommendation viewport. The file decapsulation device requests the metadata track of the recommendation viewport to the file encapsulation device according to the second information. The file encapsulation device transmits the metadata track of the recommendation viewport to the file decapsulation device.

In some embodiments, the above second information may be transmitted before the above first information.

In some embodiments, the above second information may be transmitted after the above first information.

In some embodiments, the above second information is transmitted simultaneously with the above first information.

In this embodiment, the second feature information of the attribute instance is included in the metadata track of the recommendation viewport, when the type of the attribute instance is the attribute instance associated with the recommendation viewport. Accordingly, having obtained the metadata track of the recommendation viewport according to the above steps, the file decapsulation device obtains the second feature information of the attribute instance from the metadata track of the recommendation viewport, and determines the target attribute instance according to the second feature information of the attribute instance. For example, the file decapsulation device determines the attribute instance corresponding to the second feature information as the target attribute instance.

After determining the target attribute instance to be decoded according to the above steps, the file decapsulation device performs the following S605.

S605: The file decapsulation device transmits first request information to the file encapsulation device, the first request information being used for requesting a media file of the target attribute instance.

For example, the first request information includes an identification of the target attribute instance.

As another example, the first request information includes first feature information of the target attribute instance.

S606: The file encapsulation device transmits the media file of the target attribute instance to the file decapsulation device according to the first request information.

For example, the first request information includes an identification of the target attribute instance. Accordingly, the file encapsulation device queries the media file corresponding to the target attribute instance corresponding to the identification of the target attribute instance in the media file of the target point cloud, and transmits the media file of the target attribute instance to the file decapsulation device.

S607: The file decapsulation device decapsulates the media file of the target attribute instance and then decodes same to obtain the target attribute instance.

Specifically, after receiving the media file of the target attribute instance, the file decapsulation device decapsulates the media file of the target attribute instance to obtain a decapsulated bitstream of the target attribute instance, and then decodes the bitstream of the target attribute instance to obtain a decoded target attribute instance.

In some embodiments, if the attribute information of the target point cloud is encoded based on the geometry information of the point cloud, at this time, the file encapsulation device also transmits the media file of the geometry information corresponding to the target attribute instance to the file decapsulation device for decoding the geometry information. Attribute decoding is performed on the target attribute instance based on the decoded geometry information.

To further illustrate the technical solutions of the embodiments of this application, reference is made to the following specific examples.

Example one:

Step 11: Encapsulate different attribute instances in the bitstream of the target point cloud according to multiple tracks to obtain a media file F1 of the target point cloud, when there are 2 attribute instances of 1 attribute type in the bitstream of the target point cloud. The media file F1 of the target point cloud includes Track1, Track2, and Track3:

```
            Track1: GPCCComponentInfoBox: { gpcc_type =2(Geometry)}.
            Track2: GPCCComponentInfoBox: { gpcc_type =4(Attribute);
multi_attr_instance_flag=1; attr_instance_id =1; attr_instance_priority = 0; attr_instance_type=1}.
            Track3: GPCCComponentInfoBox: { gpcc_type =4(Attribute);
multi_attr_instance_flag=1; attr_instance_id =2; attr_instance_priority = 1; attr_instance_type=1}.
```

Track2 and Track3 are tracks of two attribute instances.

Step 12: Generate DASH signaling (namely, first information) for indicating first feature information of at least one attribute instance according to the information of the attribute instances in the media file F1 of the target point cloud, the DASH signaling including the following contents:

```
            Representation1: Corresponding to track1, component@component_type = ′geom′.
            Representation2: Corresponding to track2, component@component_type = ′attr′;
component@attr_instance_id=1; component@attr_instance_priority=0;
component@attr_instance_type=1.
            Representation3: Corresponding to track3, component@component_type = ′attr′;
component@attr_instance_id=2; component@attr_instance_priority=1;
component@attr_instance_type=1.
```

Dash signaling is transmitted to the file decapsulation device.

Step 13: The file decapsulation devices C1 and C2 request a point cloud media file according to the network bandwidth and the information in the DASH signaling.

In some embodiments, the file decapsulation device C1 has sufficient network bandwidth to request Representation1-Representation3, and the file decapsulation device C2 has limited network bandwidth to request Representation1-Representation2.

Step 14: Transmit the point cloud media file.

Step 15: The file decapsulation device receives the point cloud file.

Specifically, C1: According to attr_instance_type=1, 2 attribute instances received by C1 switch depending on the user interaction operation, and C1 can obtain a more personalized point cloud consumption experience.

C2: C2 only receives 1 attribute instance and obtains a basic point cloud consumption experience.

Example two:

Step 21: Encapsulate different attribute instances in the bitstream of the target point cloud according to multiple tracks to obtain a media file F1 of the target point cloud, when there are 2 attribute instances of 1 attribute type in the bitstream of the target point cloud. The media file F1 of the target point cloud includes Track1, Track2, and Track3:

```
            Track1: GPCCComponentInfoBox: { gpcc_type =2(Geometry)}.
            Track2: GPCCComponentInfoBox: { gpcc_type =4(Attribute);
multi_attr_instance_flag=1; attr_instance_id =1; attr_instance_priority = 0; attr_instance_type=0}.
            Track3: GPCCComponentInfoBox: { gpcc_type =4(Attribute);
multi_attr_instance_flag=1; attr_instance_id =2; attr_instance_priority = 0; attr_instance_type=0}.
```

Track2 and Track3 are tracks of two attribute instances.

Step 22: Generate DASH signaling (namely, first information) for indicating first feature information of at least one attribute instance according to the information of the attribute instances in the media file F1 of the target point cloud, the DASH signaling including the following contents:

```
            Representation1: Corresponding to track1, component@component_type = ′geom′.
            Representation2: Corresponding to track2, component@component_type = ′attr′;
component@attr_instance_id=1; component@attr_instance_priority=0;
component@attr_instance_type=0.
            Representation3: Corresponding to track3, component@component_type = ′attr′;
component@attr_instance_id=2; component@attr_instance_priority=0;
component@attr_instance_type=0.
```

Dash signaling is transmitted to the file decapsulation device.

Step 23: The file decapsulation devices C1 and C2 request a point cloud media file according to the network bandwidth and the information in the DASH signaling.

C1: The network bandwidth is sufficient to request 2 attribute instances.

C2: Although the priorities of the representation2 and 3 are the same, since the two attribute instances are associated with the recommendation viewport, only 1 attribute instance can be requested at a time according to the second feature information of the attribute instance in the metadata track of the recommendation viewport and according to the media resource corresponding to the request of the user viewing position.

Step 24: Transmit the point cloud media file.

Step 25: The file decapsulation device receives the point cloud file.

C1: According to attr_instance_type=0, having received 2 attribute instances, C1 selects one attribute instance thereof to decode for consumption according to the user viewport.

C2: C2 only receives 1 attribute instance and decodes the corresponding attribute instance for consumption.

An embodiment of this application provides encapsulation and decapsulation methods for a point cloud media file. The file encapsulation device transmits the first information to the file decapsulation device, the first information being used for indicating the first feature information of at least one attribute instance of M attribute instances. Accordingly, the file decapsulation device can select to request the target attribute instance for consumption according to the first feature information of at least one attribute instance and the self-performance of the file decoding device, thereby saving the network broadband and improving the decoding efficiency.

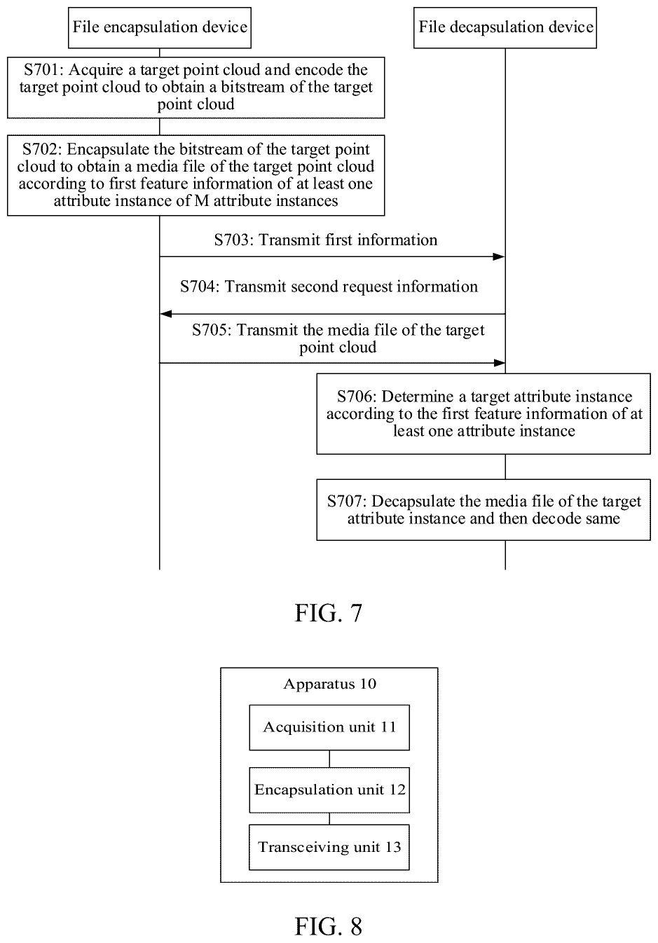

FIG. 7 is a flowchart of interactive encapsulation and decapsulation methods for a point cloud media file provided in an embodiment of this application. As shown in FIG. 7, this embodiment includes the following steps:

S701: A file encapsulation device acquires a target point cloud and encodes the target point cloud to obtain a bitstream of the target point cloud.

The target point cloud includes N types of attribute information, and at least one type of attribute information of the N types of attribute information includes M attribute instances, where the N is a positive integer, and the M is a positive integer greater than 1.

S702: The file encapsulation device encapsulates the bitstream of the target point cloud to obtain a media file of the target point cloud according to first feature information of at least one attribute instance of the M attribute instances, the media file of the target point cloud including the first feature information of the at least one attribute instance.

The above S701 and the above S702 can be implemented as described in the detailed description of the above S501 to the above S502, which will not be repeated herein.

The file encapsulation device encodes and encapsulates the target point cloud according to the above steps. After obtaining the media file of the target point cloud, the file encapsulation device can perform data interaction with the file decapsulation device in the following several methods:

Method one: The file encapsulation device can directly transmit the encapsulated media file of the target point cloud to the file decapsulation device such that the file decapsulation device selectively consumes some attribute instances according to the first feature information of the attribute instances in the media file.

Method two: The file encapsulation device transmits a signaling to the file decapsulation device, and the file decapsulation device requests all or part of the media files of the attribute instances to consume to the file encapsulation device according to the signaling.

In this embodiment, the process that the file decapsulation device requests the media file of the complete target point cloud and then selects to decode part of the media files of the attribute instances to consume in method two is described, with specific reference to the following S703 to step 707.

S703: The file encapsulation device transmits first information to a file decapsulation device.

The first information is used for indicating the first feature information of at least one attribute instance of the M attribute instances.

The first feature information of the attribute instance includes at least one of an identification of the attribute instance, a priority of the attribute instance, and a type of the attribute instance.

In some embodiments, the above first information is DASH signaling.

In some embodiments, if the above first information is DASH signaling, the semantic description of the DASH signaling is as shown in the above Table 4:

S704: The file decapsulation device transmits the second request information to the file encapsulation device according to the first information.

The second request information is used for requesting a media file of a target point cloud.

S705: The file encapsulation device transmits the media file of the target point cloud to the file decapsulation device according to the second request information.

S706: The file decapsulation device determines a target attribute instance according to the first feature information of at least one attribute instance.

The implementation process of S706 is consistent with the above implementation process of S604. With reference to the above description of S604, for example, the file decapsulation device determines the target attribute instance from the at least one attribute instance according to the first feature information of the at least one attribute instance of M pieces of attribute information, when the type of the attribute instance is an attribute instance associated with user feedback. As another example, the file decapsulation device acquires a metadata track of a recommendation viewport, when the type of the attribute instance is an attribute instance associated with the recommendation viewport, and determines the target attribute instance from the at least one attribute instance of the M pieces of attribute information according to second feature information of an attribute instance included in the metadata track of the recommendation viewport.

S707: The file decapsulation device decapsulates the media file of the target attribute instance and then decodes same to obtain the target attribute instance.

Upon the completion of determining the target attribute instance to be decoded according to the above steps, a media file corresponding to the target attribute instance is queried from the received media file of the target point cloud. Next, the file decapsulation device decapsulates the media file of the target attribute instance to obtain a decapsulated bitstream of the target attribute instance, and then decodes the bitstream of the target attribute instance to obtain a decoded target attribute instance.

An embodiment of this application provides encapsulation and decapsulation methods for a point cloud media file. The file encapsulation device transmits the first information to the file decapsulation device, the first information being used for indicating the first feature information of at least one attribute instance of M attribute instances. Accordingly, having requested the media file of the complete target point cloud, the file decapsulation device can select the target attribute instance to decode for consumption according to the first feature information of at least one attribute instance and the self-performance of the file decoding device, thereby saving the network broadband and improving the decoding efficiency.

It is to be understood that FIG. 5 to FIG. 7 are merely examples of this application and are not to be construed as limiting this application.

The embodiments of this application have been described in detail with reference to the drawings. However, this application is not limited to the specific details of the above embodiments, and various modifications can be made to the technical solutions of this application within the scope of the technical concept of this application, which fall within the scope of this application. For example, the specific features described in the above detailed description may be combined in any suitable method without contradictions, and this application will not describe every possible combination in order to avoid unnecessary repetition. As another example, any combination of the various embodiments of this application can be made without departing from the ideas of this application, which is likewise to be regarded as disclosed herein.

The method embodiments of this application are described in detail above in connection with FIG. 5 and FIG. 7, and the apparatus embodiments of this application are described in detail below in connection with FIG. 8 to FIG. 10.

FIG. 8 is a schematic structural diagram of an encapsulation apparatus for a point cloud media file provided in an embodiment of this application, and the apparatus 10 is applied to a file encapsulation device, and the apparatus 10 includes:
an acquisition unit 11, configured to acquire a target point cloud and encode the target point cloud to obtain a bitstream of the target point using a file encapsulation device, the target point cloud including N types of attribute information, at least one type of attribute information of the N types of attribute information including M attribute instances, the N being a positive integer, and the M being a positive integer greater than 1;
an encapsulation unit 12, configured to encapsulate the bitstream of the target point cloud to obtain a media file of the target point cloud according to first feature information of at least one attribute instance of the M attribute instances, the media file of the target point cloud including the first feature information of the at least one attribute instance.

In some embodiments, the first feature information of the attribute instance includes: at least one of an identification of the attribute instance, a priority of the attribute instance, and a type of the attribute instance.

In some embodiments, the type of the attribute instance includes at least one of an attribute instance associated with a recommendation viewport and an attribute instance associated with user feedback.

In some embodiments, the encapsulation unit 12 is also configured to add second feature information of the attribute instance to a metadata track of the recommendation viewport associated with the attribute instance, when the type of the attribute instance is the attribute instance associated with the recommendation viewport.

In some embodiments, the second feature information of the attribute instance includes at least one of an identification of the attribute instance and an attribute type of the attribute instance.

In some embodiments, the encapsulation unit 12 is further configured to add the first feature information of the at least one attribute instance to a sub-sample information box corresponding to the M attribute instances, when geometry information and attribute information of a frame of point cloud in the target point cloud are encapsulated in a track or an item; or
add the first feature information of the at least one attribute instance to a component information box corresponding to the M attribute instances, when each attribute instance of the M attribute instances is encapsulated in a track or an item; or
add the first feature information of the at least one attribute instance to a track group box or an entity group box, when each attribute instance of the M attribute instances is encapsulated in a track or an item, and M tracks corresponding to the M attribute instances constitute the track group, or M items corresponding to the M attribute instances constitute the entity group.

In some embodiments, the encapsulation unit 12 is also configured to link tracks of the M attribute instances by a track group box, when the M attribute instances are encapsulated in the tracks of the M attribute instances on a one-to-one basis; or
link items of the M attribute instances by an entity group box, when the M attribute instances are encapsulated in the items of the M attribute instances on a one-to-one basis.

In some embodiments, the apparatus also includes a transceiving unit 13, configured to transmit first information to a file decapsulation device, the first information being used for indicating the first feature information of the at least one attribute instance of the M attribute instances.

In some embodiments, the transceiving unit 13 is configured to receive first request information transmitted by the file decapsulation device, the first request information being used for requesting a media file of a target attribute instance; and transmit the media file of the target attribute instance to the file decapsulation device according to the first request information.

In some embodiments, the transceiving unit 13 is also configured to receive second request information transmitted by the file decapsulation device, the second request information being used for requesting a media file of a target point cloud; and transmit the media file of the target point cloud to the file decapsulation device according to the second request information.

It is to be understood that the apparatus embodiments and the method embodiments may correspond to each other and similar descriptions may refer to the method embodiments. In order to avoid repetition, it will not be repeated herein. Specifically, the apparatus 10 shown in FIG. 8 may perform a corresponding method embodiment of the file encapsulation device, and the foregoing and other operations and/or functions of the various modules in the apparatus 10 for implementing the corresponding method embodiment of the file encapsulation device, will not be described in detail herein for the sake of brevity.

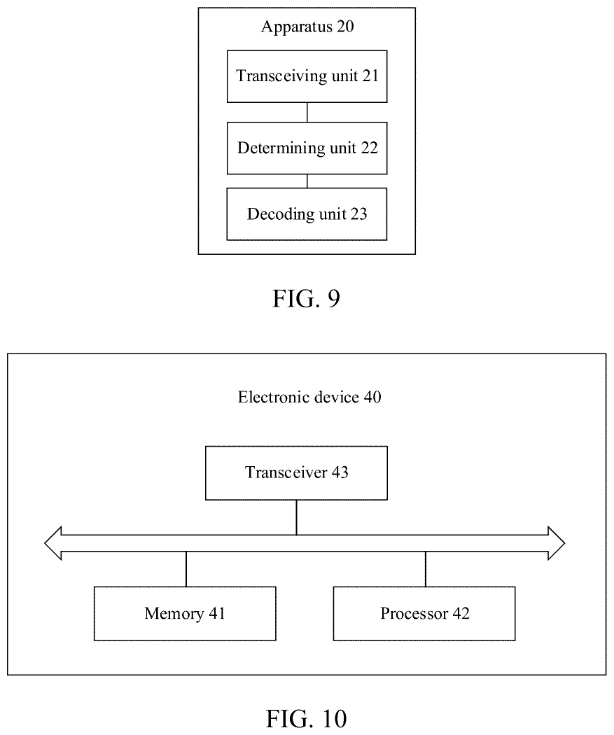

FIG. 9 is a schematic structural diagram of a decapsulation apparatus for a point cloud media file provided in an embodiment of this application, and the apparatus 20 is applied to a file decapsulation device, and the apparatus 20 includes:
a transceiving unit 21, configured to receive first information transmitted by a file encapsulation device;
the first information being used for indicating first feature information of at least one attribute instance of M attribute instances, the M attribute instances being M attribute instances included in at least one type of attribute information of N types of attribute information included in a target point cloud, the N being a positive integer, and the M being a positive integer greater than 1.

In some embodiments, the first feature information of the attribute instance includes: at least one of an identification of the attribute instance, a priority of the attribute instance, and a type of the attribute instance.

In some embodiments, the type of the attribute instance includes at least one of an attribute instance associated with a recommendation viewport and an attribute instance associated with user feedback.

In some embodiments, second feature information of the attribute instance is added to a metadata track of the recommendation viewport associated with the attribute instance, when the type of the attribute instance is the attribute instance associated with the recommendation viewport.

In some embodiments, the apparatus also includes a determining unit 22 and a decoding unit 23.

The determining unit 22 is configured to determine the target attribute instance according to the first feature information of the at least one attribute instance.

The transceiving unit 21 is configured to transmit first request information to the file encapsulation device, the first request information being used for requesting a media file of the target attribute instance; and receive the media file of the target attribute instance transmitted by the file encapsulation device.

The decoding unit 23 is configured to decapsulate the media file of the target attribute instance and then decode same to obtain the target attribute instance.

In some embodiments, the transceiving unit 21 is also configured to transmit second request information to the file encapsulation device according to the first information, the second request information being used for requesting a media file of the target point cloud; and receive the media file of the target point cloud transmitted by the file encapsulation device.

The determining unit 22 is configured to determine the target attribute instance according to the first feature information of the at least one attribute instance.

The decoding unit 23 is configured to acquire a media file of the target attribute instance from the media file of the target point cloud; and decapsulate the media file of the target attribute instance and then decode same to obtain the target attribute instance.

In some embodiments, if the first feature information of the attribute instance includes the type of the attribute instance, the determining unit 22 is further configured to determine the target attribute instance from the at least one attribute instance according to the first feature information of the at least one attribute instance of M pieces of attribute information, when the type of the attribute instance is an attribute instance associated with user feedback; or
acquire a metadata track of a recommendation viewport, when the type of the attribute instance is an attribute instance associated with the recommendation viewport, and determine the target attribute instance from the at least one attribute instance of the M pieces of attribute information according to second feature information of an attribute instance included in the metadata track of the recommendation viewport.

In some embodiments, the second feature information of the attribute instance includes at least one of an identification of the attribute instance and an attribute type of the attribute instance.

In some embodiments, the first feature information of the attribute instance is added to a sub-sample information box corresponding to the M attribute instances, when geometry information and attribute information of a frame of point cloud in the target point cloud are encapsulated in a track or an item; or
the first feature information of the attribute instance is added to a component information box corresponding to the M attribute instances, when each attribute instance of the M attribute instances is encapsulated in a track or an item; or
the first feature information of the attribute instance is added to a track group box or an entity group box, when each attribute instance of the M attribute instances is encapsulated in a track or an item, and M tracks corresponding to the M attribute instances constitute the track group, or M items corresponding to the M attribute instances constitute the entity group.

In some embodiments, the media file of the target point cloud includes a track group box, and the track group box is configured to link tracks of the M attribute instances, when the M attribute instances are encapsulated in the tracks of the M attribute instances on a one-to-one basis; or the media file of the target point cloud includes an entity group box, and the entity group box is configured to link items of the M attribute instances, when the M attribute instances are encapsulated in the items of the M attribute instances on a one-to-one basis.

It is to be understood that the apparatus embodiments and the method embodiments may correspond to each other and similar descriptions may refer to the method embodiments. In order to avoid repetition, it will not be repeated herein. Specifically, the apparatus 20 shown in FIG. 9 may perform a corresponding method embodiment of the file decapsulation device, and the foregoing and other operations and/or functions of the various modules in the apparatus 20 for implementing the corresponding method embodiment of the file decapsulation device, will not be described in detail herein for the sake of brevity.

The apparatus of an embodiment of this application is described above from the perspective of functional modules with reference to the drawings. It is to be understood that the functional modules may be implemented by hardware, as instructions in software, or by a combination of hardware and software modules. Specifically, the steps of a method embodiment of the embodiments of this application may be implemented by the integrated logic circuit in hardware and/or as instructions in software of a processor. The steps of the method disclosed in connection with the embodiments of this application may be directly embodied in execution by a hardware decoding processor, or may be implemented by a combination of hardware and software modules of a decoding processor. In some embodiments, the software module may be located in the storage medium well known in the art, such as random access memory, flash memory, Read-Only Memory (ROM), Programmable ROM (PROM), Electrically Erasable PROM, and register. The storage medium is located in the memory, and the processor reads the information in the memory and performs the steps in the above method embodiments in conjunction with its hardware.

FIG. 10 is a schematic block diagram of an electronic device provided in an embodiment of this application. The electronic device may be the above file encapsulation device or the file decapsulation device, or the electronic device has the functions of the file encapsulation device and the file decapsulation device.

As shown in FIG. 10, the electronic device 40 may include:
a memory 41 and a memory 42. Memory 41 is configured to store a computer program and transmit the program code to memory 42. In other words, memory 42 can be invoked from the memory 41 and run the computer program to perform the methods of the embodiments of this application.

For example, memory 42 may be configured to perform the method embodiments described above according to the instructions of the computer program.

In some embodiments of this application, the memory 42 may include, but is not limited to:
General-Purpose Processor, Digital Signal Processor (DSP), Application Specific Integrated Circuit (ASIC), Field Programmable Gate Array (FPGA) or other programmable logic device, discrete gate or transistor logic device, and discrete hardware component.

In some embodiments of this application, the memory 41 includes, but is not limited to:
volatile memory and/or non-volatile memory. The non-volatile memory may be Read-Only Memory (ROM), Programmable ROM (PROM), Erasable PROM (EPROM), Electrically EPROM (EEPROM), or flash memory. Volatile memory can be Random Access Memory (RAM), which acts as external cache. Through exemplary but not limited illustration, many forms of RAM are available such as Static RAM (SRAM), Dynamic RAM (DRAM), Synchronous DRAM (SDRAM), Double Data Rate SDRAM (DDR SDRAM), Enhanced SDRAM (ESDRAM), Synch Link DRAM (SLDRAM), and Direct Rambus RAM (DR RAM).

In some embodiments of this application, the computer program may be partitioned into one or more modules that are stored in memory 41 and executed by the memory 42 to perform the methods provided herein. The one or more modules may be a series of computer program instruction segments capable of performing specific functions. The instruction segments are used for describing the execution of the computer program in the video producing device.

As shown in FIG. 10, the electronic device 40 may also include:
a transceiver 43. The transceiver 43 may be connected to memory 42 or the memory 41.

The memory 42 can control the transceiver 43 to communicate with other devices. Specifically, the memory can transmit information or data to other devices or receive information or data from other devices. Transceiver 43 may include a transmitter and a receiver. The transceiver 43 may further include antennas, and the number of antennas may be one or more.

It is to be understood that the various components of the video producing device are connected by a bus system that includes a power bus, a control bus, and a status signal bus in addition to a data bus.

This application also provides a computer storage medium, configured to store a computer program thereon, when executed by a computer, causing the computer to perform the methods of the above method embodiments. Alternatively, an embodiment of this application also provides a computer program product comprising instructions, when executed by a computer, causing the computer to perform the methods of the above method embodiments.

In embodiments of the present disclosure, software functions may be implemented in whole or in part as a computer program product. The computer program product includes one or more computer instructions. The computer program instructions, when loaded and executed on the computer, produce, in whole or in part, flows or functions according to embodiments of this application. The computer may be a general-purpose computer, a special-purpose computer, a computer network, or other programmable apparatus. The computer instructions may be stored in a computer-readable storage medium or transmitted from a computer-readable storage medium to another computer-readable storage medium. For example, the computer instructions may be transmitted from a website, computer, server, or data center to another website, computer, server, or data center in a wired (e.g., coaxial cable, fiber optic, and digital subscriber line (DSL)) or wireless (e.g., infrared, wireless, and microwave) method. The computer-readable storage medium may be any available medium that can be accessed by a computer or a data storage device comprising a server and a data center integrated by one or more available media. The available medium may be magnetic medium (e.g., soft disk, hard disk, and magnetic tape), optical medium (e.g., digital video disc (DVD)), or semiconductor medium (e.g., solid state disk (SSD)), and the like.

Those skilled in the art should recognize that the modules and algorithm steps of the examples described in connection with the embodiments disclosed herein can be implemented as electronic hardware, or combinations of computer software and electronic hardware. Whether these functions are implemented as hardware or software depends upon the specific application and design constraints of the technical solutions. Those skilled in the art may implement the described functions using various ways for each specific application, but such implementation is not to be interpreted as departing from the scope of this application.

In the several embodiments provided in this application, the disclosed system, apparatus, and method may be implemented using other methods. For example, the apparatus embodiments described above are merely illustrative, e.g., the division of the module is merely a logically functional division. In one embodiment, there may be additional division, e.g., a plurality of modules or components may be combined or integrated into another system, or some features may be omitted or not performed. In another aspect, the coupling or direct coupling or communicated connection shown or discussed with respect to each other may be an indirect coupling or communicated connection through some interfaces, apparatuses or modules, and may be electrical, mechanical or otherwise.

The module illustrated as separate component may or may not be physically separated. The member shown as the module may or may not be a physical module, i.e., may be located in one place, or may also be distributed over a plurality of network units. Part or all of the modules thereof may be selected to achieve the object of the solution of this embodiment. For example, each functional module in the embodiments of this application may be integrated into one processing module, or each module may physically exist separately, or two or more modules may be integrated in one module.

The above is only the detailed description of this application, but the scope of protection of this application is not limited thereto. It will be apparent to those skilled in the art that various changes and replacements may be made without departing from the scope of protection of this application, which shall fall within the scope of protection of this application. Therefore, the scope of protection of this application is to be determined by the claims.

What is claimed is:

1. An encapsulation method for a point cloud media file, applied to a file encapsulation device, the method comprising:
acquiring a target point cloud and encoding the target point cloud to obtain a bitstream, the target point cloud comprising at least one type of attribute information, each type of attribution information comprising M attribute instances of instance data, and M being a positive integer greater than 1; and
encapsulating the bitstream of the target point cloud according to first feature information of at least one attribute instance of M attribute instances to obtain a media file, the media file comprising the first feature information of the at least one attribute instance.

2. The method according to claim 1, wherein the first feature information of the attribute instance comprises: at least one of an identification of the attribute instance, a priority of the attribute instance, and a type of the attribute instance.

3. The method according to claim 2, wherein the type of the attribute instance comprises at least one of an attribute instance associated with a recommendation viewport and an attribute instance associated with user feedback.

4. The method according to claim 3, wherein when the type of the attribute instance is the attribute instance associated with the recommendation viewport, the method further comprises:
adding second feature information of the attribute instance to metadata of the recommendation viewport associated with the attribute instance.

5. The method according to claim 4, wherein the second feature information of the attribute instance comprises at least one of an identification of the attribute instance and an attribute type of the attribute instance.

6. The method according to claim 1, wherein encapsulating the bitstream of the target point cloud according to first feature information of at least one attribute instance of M attribute instances to obtain an media file comprises:
adding the first feature information of the at least one attribute instance to a sub-sample information box corresponding to the M attribute instances, when geometry information and attribute information of a frame of point cloud in the target point cloud are encapsulated in a track or an item; or
adding the first feature information of the at least one attribute instance to a component information box corresponding to the M attribute instances, when each attribute instance of the M attribute instances is encapsulated in a track or an item; or
adding the first feature information of the at least one attribute instance to a track group box or an entity group box, when each attribute instance of the M attribute instances is encapsulated in a track or an item, and M tracks corresponding to the M attribute instances constitute the track group, or M items corresponding to the M attribute instances constitute the entity group.

7. The method according to claim 1, further comprising:
linking tracks of the M attribute instances by a track group box, when the M attribute instances are encapsulated in the tracks of the M attribute instances on a one-to-one basis; or
linking items of the M attribute instances by an entity group box, when the M attribute instances are encapsulated in the items of the M attribute instances on a one-to-one basis.

8. The method according to claim 1, further comprising:
transmitting first information to a file decapsulation device, the first information indicating the first feature information of the at least one attribute instance of the M attribute instances.

9. The method according to claim 8, further comprising:
receiving first request information transmitted by the file decapsulation device, the first request information requesting a media file of a target attribute instance; and
transmitting the media file of the target attribute instance to the file decapsulation device according to the first request information.

10. The method according to claim 8, further comprising:
receiving second request information transmitted by the file decapsulation device, the second request information requesting a media file of a target point cloud; and
transmitting the media file of the target point cloud to the file decapsulation device according to the second request information.

11. A decapsulation method for a point cloud media file, applied to a file decapsulation device, the method comprising:
receiving first information transmitted by a file encapsulation device, the first information indicating first feature information of at least one attribute instance of M attribute instances in a target point cloud, and M being a positive integer greater than 1; and
determining a target attribute instance from the at least one attribute instance using the first feature information, and acquiring instance data corresponding to the target attribute instance.

12. The method according to claim 11, wherein the first feature information of the attribute instance comprises: at least one of an identification of the attribute instance, a priority of the attribute instance, and a type of the attribute instance.

13. The method according to claim 12, wherein the type of the attribute instance comprises at least one of an attribute instance associated with a recommendation viewport and an attribute instance associated with user feedback.

14. The method according to claim 13, wherein second feature information of the attribute instance is added to metadata of the recommendation viewport associated with the attribute instance, when the type of the attribute instance is the attribute instance associated with the recommendation viewport.

15. The method according to claim 11, wherein the acquiring instance data corresponding to the target attribute instance comprises:
transmitting first request information to the file encapsulation device, the first request information requesting a media file of the target attribute instance;
receiving the media file corresponding to the target attribute instance transmitted by the file encapsulation device; and
decapsulating the media file and then decoding same to obtain the instance data of the target attribute instance.

16. The method according to claim 11, further comprising:
transmitting second request information to the file encapsulation device according to the first information, the second request information requesting a media file of the target point cloud;
receiving the media file of the target point cloud transmitted by the file encapsulation device;
acquiring a media file of the target attribute instance from the media file of the target point cloud; and
decapsulating the media file of the target attribute instance and then decoding same to obtain the instance data of the target attribute instance.

17. The method according to claim 15, wherein when first feature information of an attribute instance comprises a type of the attribute instance, determining the target attribute instance according to the first feature information of at least one attribute instance comprises:
determining the target attribute instance from the at least one attribute instance according to the first feature information of the at least one attribute instance of M pieces of attribute information, when the type of the attribute instance is an attribute instance associated with user feedback; or
acquiring a metadata of a recommendation viewport, when the type of the attribute instance is an attribute instance associated with the recommendation viewport, and determining the target attribute instance from the at least one attribute instance of the M pieces of attribute information according to second feature information of an attribute instance comprised in the metadata of the recommendation viewport.

18. The method according to claim 14, wherein the second feature information of the attribute instance comprises at least one of an identification of the attribute instance and an attribute type of the attribute instance.

19. The method according to claim 11, wherein
the first feature information of the attribute instance is added to a sub-sample information box corresponding to the M attribute instances, when geometry information and attribute information of a frame of point cloud in the target point cloud are encapsulated in a track or an item; or
the first feature information of the attribute instance is added to a component information box corresponding to the M attribute instances, when each attribute instance of the M attribute instances is encapsulated in a track or an item; or
the first feature information of the attribute instance is added to a track group box or an entity group box, when each attribute instance of the M attribute instances is encapsulated in a track or an item, and M tracks corresponding to the M attribute instances constitute the track group, or M items corresponding to the M attribute instances constitute the entity group.

20. A non-transitory computer-readable storage medium, configured to store a computer program for causing a computer to perform an encapsulation method for a point cloud media file, executed by one or more processors, the method comprising:
acquiring a target point cloud and encoding the target point cloud to obtain a bitstream, the target point cloud comprising at least one type of attribute information, each type of attribution information comprising M attribute instances of instance data, and M being a positive integer greater than 1; and
encapsulating the bitstream of the target point cloud according to first feature information of at least one attribute instance of M attribute instances to obtain a media file, the media file comprising the first feature information of the at least one attribute instance.
